(19) United States
(12) Patent Application Publication
(10) Pub. No.: US 2009/0223945 A1
(43) Pub. Date: Sep. 10, 2009

(54) TEMPERATURE CONTROLLED FOOD STORAGE COMPARTMENT

(75) Inventors: Jeffrey David Koon, Lombard, IL (US); Donald Robinson, Bolingbrook, IL (US); Suzanne Johnson, Naperville, IL (US)

Correspondence Address: BROOKS KUSHMAN P.C., 1000 TOWN CENTER, TWENTY-SECOND FLOOR, SOUTHFIELD, MI, 48075, US

(73) Assignee: TAYLOR PRECISION PRODUCTS, INC., Oak Brook, IL (US)

(21) Appl. No.: 12/397,562

(22) Filed: Mar. 4, 2009

Related U.S. Application Data
(60) Provisional application No. 61/033,627, filed on Mar. 4, 2008.

(51) Int. Cl. A21B 1/52; A21B 1/40

(52) U.S. Cl. 219/387; 219/399

(57) ABSTRACT

A portable, temperature controlled food storage compartment. The compartment includes a base having an internal cavity including a temperature controlling element for controlling the temperature of food stored in the compartment, and a detachable cover including a number of side panels, a front panel and a top panel. Each of the number of side panels is pivotally connected to the top panel. The front panel is pivotally connected to the number of side panels. The cover is configurable in a food storage position in which a lower edge portion of each of the number of side panels is coupled to the base to form an interior volume at least partially defined by the base and the cover and for storing food. The cover is configurable in a collapsed position in which at least one surface portion of at least one of the number of side panels and the top panel contacts the base.

### CROSS-REFERENCE TO RELATED APPLICATIONS

This application claims the benefit of U.S. provisional application Ser. No. 61/033,627 filed Mar. 4, 2008, which is incorporated by reference in its entirety.

### BACKGROUND

1. Technical Field

One or more embodiments relate to temperature controlled food storage compartments.

2. Background Art

U.S. Pat. No. 3,714,394 to Evans discloses a portable electric oven. U.S. Pat. No. 5,495,845 to Hait discloses a compact outdoor cooking unit having a cooking mode and a transport and storage mode. U.S. Pat. No. 5,921,229 to Blake discloses a hand-portable, light-weight cooker/heating device.

### BRIEF DESCRIPTION OF THE DRAWINGS

FIG. 1a is a top perspective view of a temperature controlled food storage compartment in a closed position according to one or more embodiments;

FIG. 1b is a plan view of the vent of the temperature controlled storage compartment of FIG. 1a;

FIG. 1c is a top perspective view of a temperature controlled food storage compartment base including a clip according to one or more embodiments;

FIG. 2 is a top perspective view of a temperature controlled food storage compartment in an open position according to one or more embodiments;

FIG. 3 is a top perspective view of a temperature controlled food storage compartment in an open position and including a storage rack according to one or more embodiments;

FIG. 4 is a top perspective view of a temperature controlled food storage compartment in an open position and including a rack according to one or more embodiments;

FIGS. 5a, 5b and 5c are bottom perspective views of a cover in different partially collapsed positions according to one or more embodiments;

FIG. 6a is a bottom perspective view of a collapsed cover of a temperature controlled storage compartment according to one or more embodiments;

FIG. 6b is a bottom perspective view of a clip for coupling a side panel and rear panel to each other according to one or more embodiments;

FIG. 7 is a top perspective view of a collapsed cover and rack supported by a base of a temperature controlled storage compartment according to one or more embodiments;

FIG. 8 is a top perspective view of a base having a handle according to one or more embodiments; and

FIG. 9 is an exploded, top perspective view of a temperature controlled storage compartment base according to one or more embodiments.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the present invention.

At least one embodiment is directed to a temperature controlled food storage compartment. In one embodiment, the controlled temperature is warmer than the ambient temperature such that the storage compartment can be utilized for keeping food warm. In another embodiment, the controlled temperature is cooler than the ambient temperature such that the storage compartment can be utilized for cooling foods. In yet another embodiment, the storage compartment can be utilized for chilling or freezing foods.

In at least one embodiment, the temperature controlled food storage compartment is portable such that it can be utilized in a number of settings, including without limitation homes, vehicles, campgrounds, tailgating, boating, and pot luck events. For example, the temperature controlled food storage compartment may be used as a kitchen counter top device. Accordingly, the portability can be provided through a temperature controlled food storage compartment comprised of a base and a collapsible cover. In one embodiment, the collapsible cover has a combination of slidable and rotatable portions to obtain the collapsed position of the cover. The collapsed position may provide a relatively flat configuration for the collapsible cover. The collapsed cover can be supported on the base for facilitating easy transport. The collapsible cover may be dishwasher safe for easy cleaning and maintenance.

According to one embodiment, the temperature controlled food storage compartment includes electrical connections for AC and DC power sources. For example, the electrical AC connection can include a removable power cord for standard home wall outlets such as 120V 60 Hz standard United States wall outlets. The electrical DC connection can include a removable power cord with an automotive lighter plug for use in a standard automobile lighter plug. In one embodiment, one or more of the cords plug into the rear edge of the base of the temperature controlled food storage compartment.

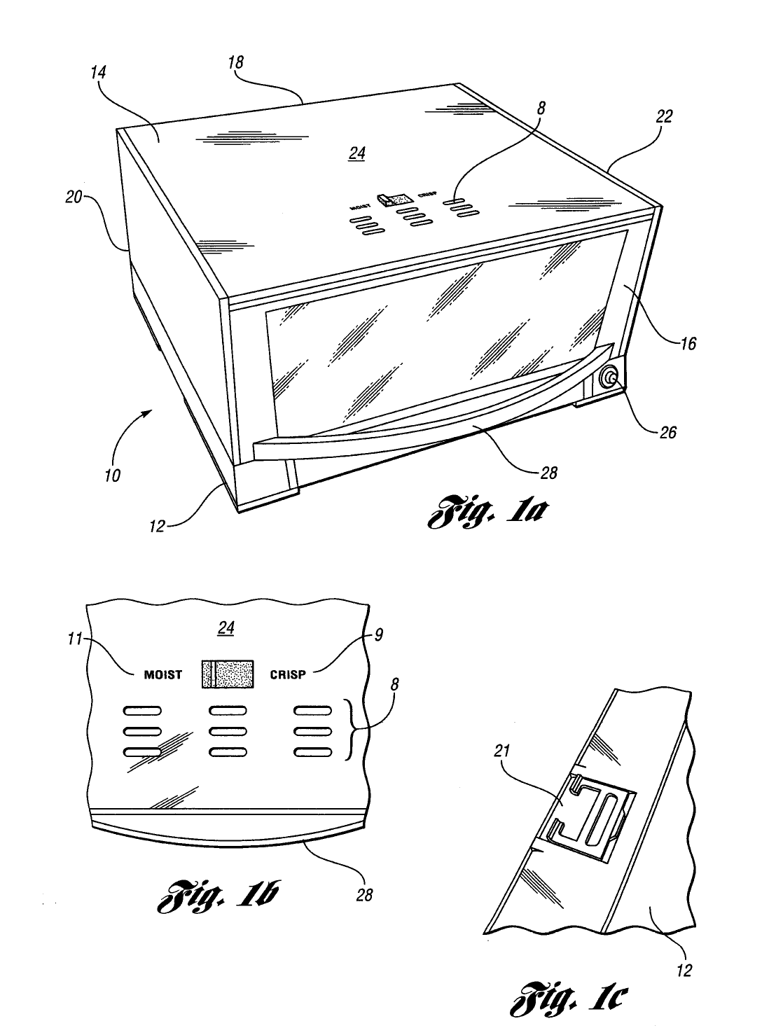

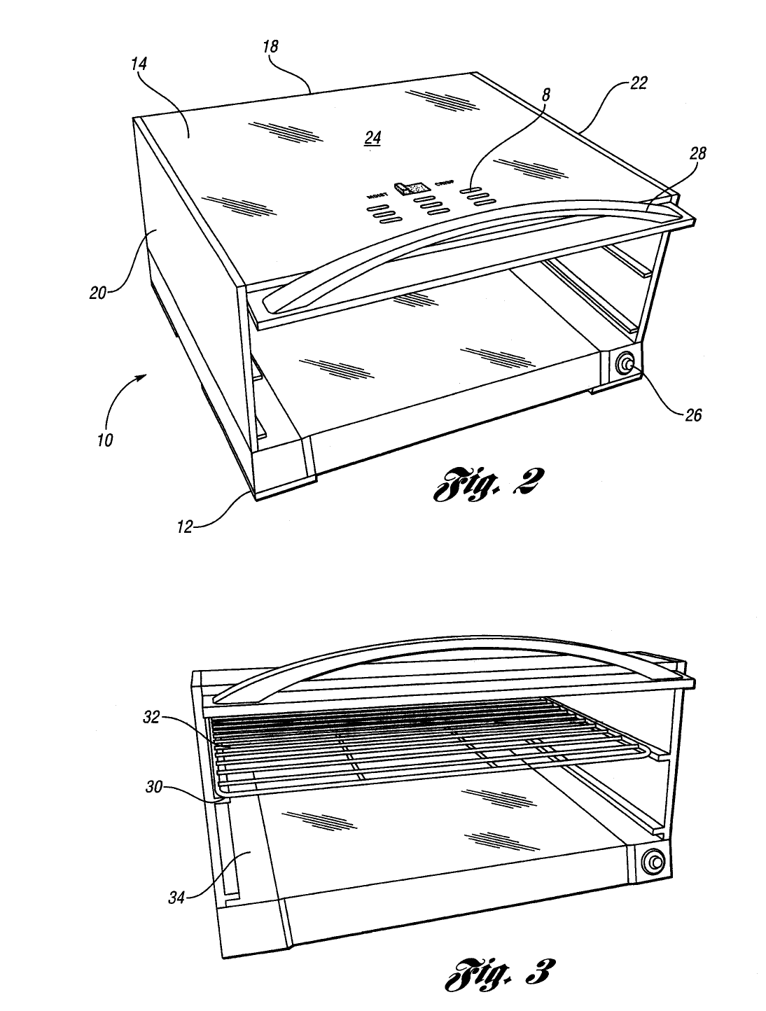

In at least one embodiment, the cover of the temperature controlled storage compartment includes a vent 8, as depicted in FIGS. 1a and 1b, for controlling the amount of moisture that enters and exits the storage compartment, thereby controlling the humidity of the storage compartment. In one embodiment, vent 8 is a levered vent disposed on the top panel of the cover. The levered vent may have multiple positional settings, including crisp and moist positional settings 9 and 11.

One or more embodiments include a temperature controlled storage compartment, as generally indicated by reference number 10 in FIGS. 1a and 2. Storage compartment 10 is utilized as a warming compartment, although in other embodiments, cooling compartments are contemplated. In one embodiment, the interior of storage compartment 10 is 18 inches wide, 16 inches deep and 7 inches high. These dimensions allow for 11 inch dinner plates, 13×9 inch casserole dishes, medium pizzas, or meat platters, for example. In another embodiment, the interior volume of storage compartment 10 is 8 inches wide, 8 inches deep and 4 inches high. In yet another embodiment, larger dimensions are utilized so that the storage compartment can be utilized for entertaining and commercial applications. In another embodiment, relatively small dimensions can be utilized so that the storage compartment can be used as a lunch box or for transportation of medications.

As shown in FIGS. 4a and 2, storage compartment 10 includes a base 12 and a cover 14 having a front panel 16, a rear panel 18, a first side panel 20, a second side panel 22, and a top panel 24. In at least one embodiment, the base 12 can be used as a stand alone warming tray apart from cover 14. In the one or more warming tray embodiments, the base 12 can be heated up to a sufficient temperature such that when a removable power cord is disconnected, the base 12 can be utilized as a warming tray for a certain amount of time, e.g., 1 hour, after disconnect.

In at least one embodiment, panels 16, 18, 20, 22 and 24 include spaced apart inner and outer walls. The space in between the walls may be filled with an air gap and/or at least partially filled with an insulating material such as 3M Thinsulate B200 or B400 insulating material. In one embodiment, the cover panels are formed of material such that the temperature on the outside surface of any panel does not exceed a predetermined temperature. In one embodiment, the predetermined external temperature is 115° F. The base may be formed of material such that the temperature on the underneath surface of the base does not exceed a predetermined temperature, such as 130° F.

In one or more embodiments, a drawer housing is provided around a collapsible cover, such as cover 14. In such embodiments, the collapsible cover would be inverted to act as a drawer that is capable of sliding into and out of the drawer housing.

In one or more embodiments, the storage compartment 10 is stackable in its closed position. In other embodiments, the storage compartment 10 is stackable in its collapsed position.

The internal surfaces and/or wall of base 12 and/or cover 14 can be made of any number of food safe materials, such as stainless steel, powder coated steel, plastic, aluminum, silicone, canvas, or relatively high heat tolerant fabric. In at least one embodiment, the materials used for the internal surfaces of cover 14 are dishwasher safe. The external surfaces and/or wall of base 12 and/or cover 14 may be made of any number of materials, such as glass, stainless steel, powder coated steel, plastic, aluminum, silicone, canvas, relatively high heat tolerant fabric and combinations thereof.

Base 12 may have a generally rectangular shape with a relatively low height so that it has a relatively low center of gravity for providing stability for supporting cover 14, although other shapes and dimensional characteristics are fully contemplated by one or more embodiments. The base may be made of an injection molded plastic, or plastic with a painted metal combination.

As best shown in FIG. 1a, storage compartment 10 is in a closed position for at least partially enclosing food products stored within storage compartment 10. In the closed position, cover 14 is supported on base 12 through contact between the lower edges of panels 16, 18, 20 and 22 and base 12. Lower edges of panels 18, 20 and 22 are positively retained by base 12 in its closed position (and open position) through the use of an appropriate retaining mechanism, such as a pin, groove, detent, or cowl. In one embodiment, clips are disposed on a middle portion of each side of base 12. The clips lock into projections disposed on a corresponding middle lower portion of panels 20 and 22. FIG. 1c shows clip 21 disposed on a middle portion of one of the sides of base 12. The clips each include an angled surface such that when cover 14 is in its closed position on base 12, a portion of each of the clips extends upward, allowing a user to grasp each clip, and push side panels 20 and 22 into a locked position. The side panels 20 and 22 each include a tab disposed proximate to and in communication with the corresponding projection such that the user can unlock the clip from the locked position to an unlocked position, in which cover 14 may be removed from base 12.

In one embodiment, a number of gaskets are secured to various locations on front panel 16 and rear panel 18. Gaskets may be secured along a top, bottom, left and/or right portion of the back surface and/or corresponding edge of front panel 16. Front panel 16 is frictionally retained in the closed position by the one or more front panel gaskets. This frictional retention minimizes the escape and/or entry of heat and moisture between panels 16, 18, 20 and 22 during use of storage compartment 10. While the one or more front panel gaskets provide for suitable frictional retention in the closed position, the gaskets also allow for relatively easy disengagement for moving front panel 18 from the closed position to the open position. Gaskets may also be secured along a top and bottom portion of the back surface and/or corresponding edge of rear panel 18. Rear panel 18 is frictionally retained in the closed position by the one or more rear panel gaskets. Non-gasket containing panel intersections include a tolerance gap for flowing air and moisture when vent 8 is in an open position.

The front region of the base 12 includes a toggle button 26 for controlling the operation of the heating element depicted in FIG. 9. The operation includes turning the heating element on or off and changing the heating element between two or more temperature settings. In one embodiment, three temperature settings, i.e., low, medium and high, are contemplated. The low temperature setting may be 140° F. The medium temperature setting may be 175° F. The high temperature setting may be 200° F. In one embodiment, the heating element delivers an internal compartment temperature within a tolerance of ±5 to 10 degrees, with the temperature being measured as the air temperature in a central region of compartment 10 (although the temperature may be measured at other locations within the internal compartment). In another embodiment, an infinite number of temperature settings can be provided by a gradual temperature dial instead of one with a discrete number of settings.

The user feels a click each time button 26 is pressed. When the heating element is off and receiving power, the first press of button 26 turns the heating element on to the low temperature setting. When the heating element is operating on the low temperature setting, pressing button 26 changes the heating element to the medium temperature setting. When the heating element is operating on the medium temperature setting, pressing button 26 changes the heating element to the high temperature setting. When the heating element is operating on the high temperature setting, pressing button 26 turns off the heating element. LED illuminated words LOW, MED and HIGH are situated on the front region of base 12 to indicate the current temperature setting of the heating element. No illuminated words indicates that the heating element is off. The front region of base 12 also includes an LED light that illuminates when the power cord is plugged into base 12. The power LED light remains lit until the power cord is removed and the heating element is no longer receiving power.

The storage compartment may include a contact safety switch (not shown) that shuts down the heating element if any of panels 18, 20 or 22 become disconnected from base 12 during use, unless base 12 is being used as a warming tray. Furthermore, the storage compartment 10 may include an automatic shutoff feature after a predetermined time of non-use, such as 3 hours±5 minutes in one or more embodiments.

As best shown in FIG. 2, storage compartment 10 is in an open position for removing and inserting food products stored within storage compartment 10. In the embodiment illustrated, front panel 16 rotates outward from its closed position depicted in FIG. 1a and up to a position 90° from the top surface of base 12, and then is slidable towards rear panel 18 on a track to the open position shown in FIG. 2. In one embodiment, front panel 16 is substantially parallel to top panel 24 when front panel 16 is in the open position. The rotating feature can be provided by a set of pins and apertures located on the sides of the front panel 16 and a front portion of side panels 20 and 22, respectively. The sliding feature can be provided by a rail, groove or track disposed on each of the inner surfaces of side panels 20 and 22. Handle 28 functions as a stop of further slidable movement in a rearward direction.

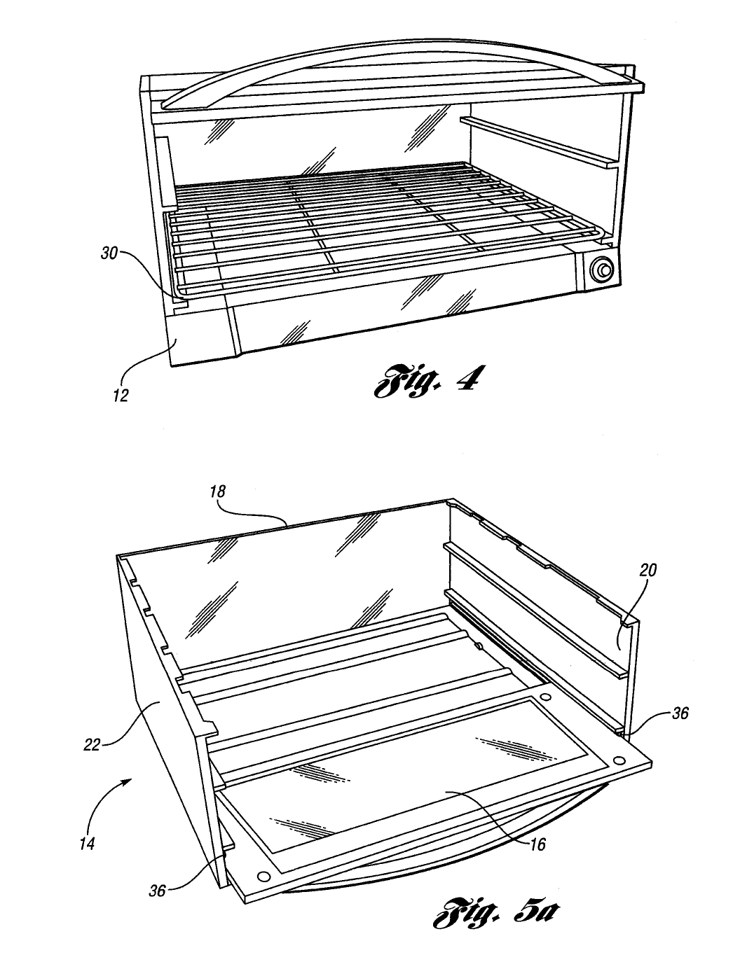

As shown in FIG. 3, storage compartment 10 is shown for storing food products according to one embodiment. The storage compartment includes rack 30 being supported by a rail, track or groove disposed on each of the inner surfaces of side panels 20 and 22. In the embodiment shown in FIG. 3, rack 30 divides the interior volume of the storage compartment 10 substantially in half so that there is an upper region 32 and lower region 34 for food storage. A first plate of food can be stored on rack 30 and a second plate of food can be stored on the upper surface of base 12. Alternatively, a first medium pizza can be stored on rack 30 and a second medium pizza can be stored on the upper surface of base 12. Alternatively, rack 30 rests on the upper surface of base 12, as depicted in FIG. 4. Rack 30 is made of a material that allows for easy removal of food being stored on rack 30 without acting as an insulator of heat between regions 32 and 34. Non-limiting examples include stainless steel wire or plated metal wire.

In another embodiment, a number of tracks, rails or grooves can be disposed on each of the inner surfaces of side panels 20 and 22 so that one or more racks can be disposed at one or more heights within storage compartment 10. In one embodiment, four molded rails are provided on the inner surfaces of side panels 20 and 22 to provide four rack positions: a center position, a high position, a low position and a bottom position.

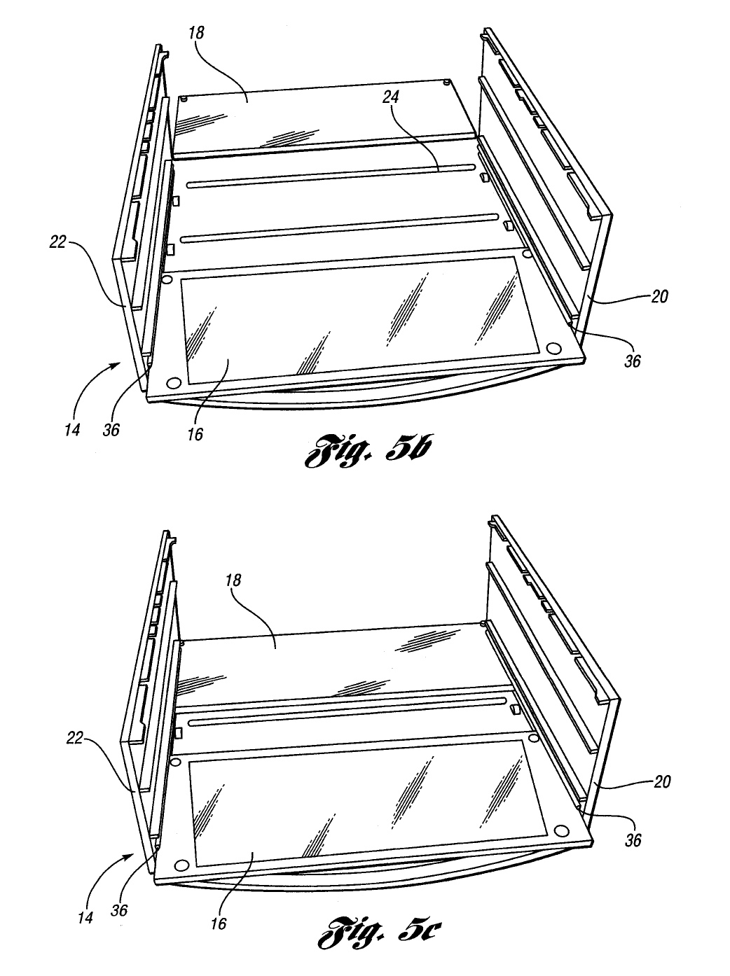

FIG. 5a is a bottom perspective view of cover 14 in a partially collapsed position. In the embodiment illustrated, front panel 16 rotates outward from its closed position depicted in FIG. 1 and up to a position 90° from the top surface of base 12, and then is slidable towards rear panel 18 on a track 36 to the partially collapsed position shown in FIG. 5a. In one embodiment, front panel 16 is substantially parallel to top panel 24 when front panel 16 is in the open position. The rotating feature can be provided by a set of pins and apertures located on the sides of the front panel 16 and a front portion of side panels 20 and 22, respectively. The sliding feature can be provided by a groove or track 36 disposed on each of the inner surfaces of side panels 20 and 22. Handle 28 functions as a stop of further slidable movement in a rearward direction.

FIG. 5b is a bottom perspective view of cover 14 in a partially collapsed position. As shown in 5b, rear panel 18 rotates outward from its closed position depicted in FIG. 1 and up to a position 90° from the top surface of base 12, and then is slidable towards front panel 16 on track 36 to the partially collapsed position as depicted in FIG. 5c. The rotating feature can be provided by a set of pins and apertures located on the sides of the rear panel 18 and a rear portion of side panels 20 and 22, respectfully. The sliding feature can be provided by track 36 disposed on each of the inner surfaces of side panels 20 and 22. As shown, track 36 extends between the front and rear edges of top panel 24. Alternatively, the track for rear panel 22 can be disposed lower than the grooves for slidable movement of front panel 16 such that no interference between panels 16 and 18 is caused, thereby allowing panels 16 and 18 to overlap.

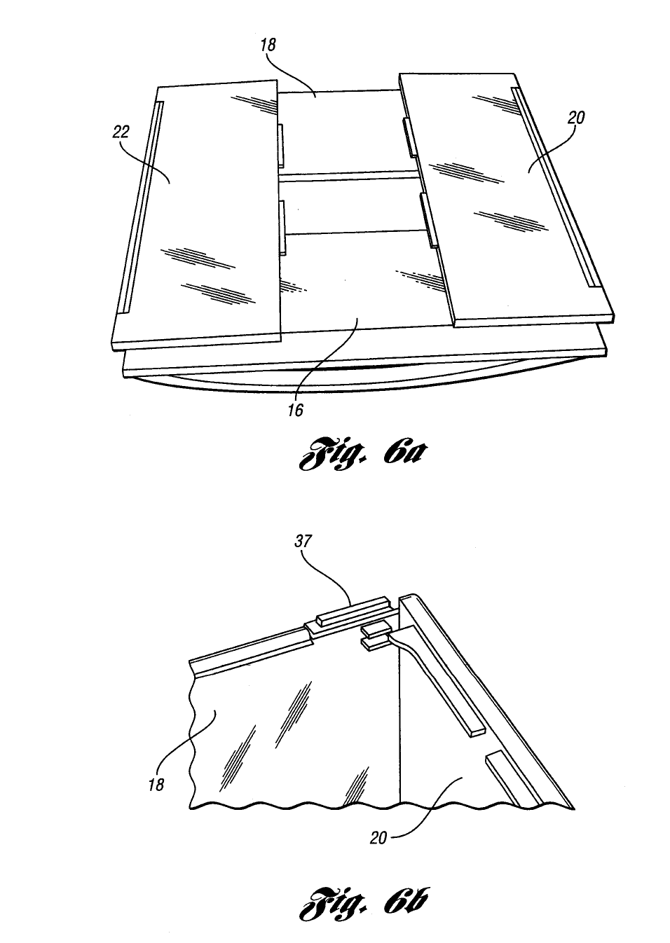

FIG. 6a is a bottom perspective view of cover 14 in a completely collapsed position. Side panels 20 and 22 rotate inward from their closed positions depicted in FIG. 1 and up to a collapsed position as depicted in FIG. 6a. At such a position, side panels 20 and 22 may be mechanically coupled to rear panel 18 through appropriate means, such as a pin, groove, detent, or cowl. As shown in FIG. 6b, clip 37 mechanically couples one of side panel 20 to rear panel 18.

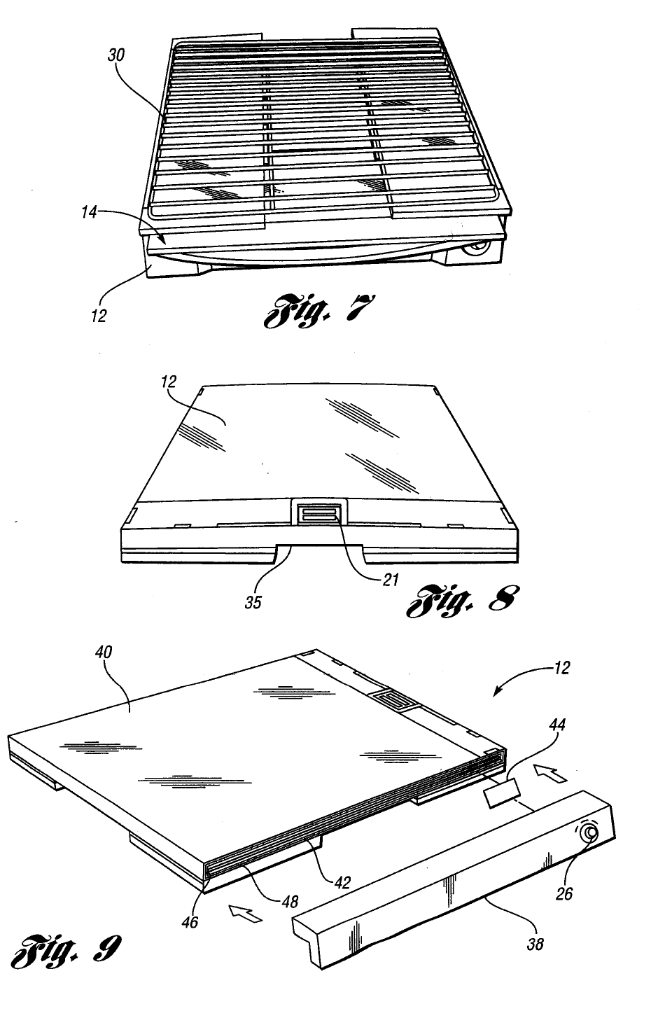

FIG. 7 is a top perspective view of a collapsed cover 14 and rack 30 supported by base 12. The collapsed cover can nest on top of and/or below the base according to one or more embodiments. In one embodiment, side panels 20 and 22 may be mechanically coupled to one more regions of base 12 through appropriate means, such as a clip, pin, groove, detent, or cowl. In another embodiment, collapsed cover 14 supports base 12.

FIG. 8 is a top perspective view of base 12 having a base handle 35 on a side edge of base 10. As depicted in FIG. 8, base handle 35 is centered along the side edge, although other locations for base handle 35 are contemplated by one or more embodiments. The opposing side edge may also include a base handle. The one or more base handles facilitate easy lifting of base 12 or the combination of base 12 and cover 14.

A storage or carry bag formed of non-woven material, for example, may be utilized for storing storage compartment when the cover is in the collapsed position. In one embodiment, the storage or carry bag includes an internal divider creating two pockets in which one pocket stores the base and the other compartment stores the other items of the storage compartment, such as the cover, the rack and one or more power cords.

FIG. 9 is an exploded, top perspective view of base 12 according to one or more embodiments. Base 12 includes front portion 38 and central portion 40. Front portion 38 is mechanically coupled to central portion 40 through a press fit or other appropriate means. As shown, button 26 is electrically connected to electronic controller 44 for controlling the amount of heat generated by heating element 42 to obtain the current temperature level indicated by the temperature LED settings. Button 26 is also electrically connected to electronic controller 44 for turning heating element 42 between on and off. In one embodiment, heating element is a conventional resistance wire heater. In embodiments where the storage compartment is utilized to cool foods, the heating element may instead be a flexible tube charged with a refrigerant. In another embodiment, the heating element is a Peltier cooler or heater. Internal cavity 46 of base 12 includes an insulating layer 48 disposed between heating element 42 and the base surface of the internal cavity 46. In one embodiment, insulating layer 48 is 3M Thinsulate B200 or B400 insulating material.

Electronic controller 44 may be configured to control operation the heating element 42 such that it takes a predetermined time period to heat compartment 10 from ambient temperature to the selected temperature level. In one embodiment, the predetermined time period for elevating the temperature to a low temperature level of 140° F. is 30 minutes or less. The predetermined time period for elevating the temperature to a medium temperature level of 175° F. is 30 minutes or less. The predetermined time period for elevating the temperature to a high temperature level of 200° F. is 30 minutes or less.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A portable, temperature controlled food storage compartment comprising:
a base having an internal cavity including a temperature controlling element for controlling the temperature of food stored in the compartment; and
a detachable cover including a number of side panels, a front panel and a top panel, each of the number of side panels is pivotally connected to the top panel, the front panel is pivotally connected to the number of side panels, the cover is configurable in a food storage position in which a lower edge portion of each of the number of side panels is coupled to the base to form an interior volume at least partially defined by the base and the cover and for storing food, and the cover is configurable in a collapsed position in which at least one surface portion of at least one of the number of side panels and the top panel contacts the base.

2. The portable, temperature controlled food storage compartment of claim 1, wherein the number of side panels includes opposing and spaced apart first and second side panels, and the front panel is pivotally connected to the first and second side panels.

3. The portable, temperature controlled food storage compartment of claim 2, wherein the detachable cover includes a rear panel opposing and spaced apart from the front panel.

4. The portable, temperature controlled food storage compartment of claim 3, wherein the first side panel including a first rail, the second side panel includes a second rail, and at least one of the front panel and the rear panel is slidably connected to the first and second side panels along the first and second rails.

5. The portable, temperature controlled food storage compartment of claim 4, wherein both of the front and rear panels are slidably connected to the first and second side panels along the first and second rails.

6. The portable, temperature controlled food storage compartment of claim 5, wherein the cover is configurable in a first partially collapsed position in which the front and rear panels are pivoted to be substantially parallel to the top cover, and subsequently slid inward such that a portion of the front and rear panels overlie the top panel.

7. The portable, temperature controlled food storage compartment of claim 6, wherein the collapsed position includes the first partially collapsed position and the first and second side panels pivoting to be substantially parallel to the front and rear panels and overlying at least a portion of the front and rear panels.

8. The portable, temperature controlled food storage compartment of claim 7, wherein the cover in the collapsed position is nestable to the base.

9. The portable, temperature controlled food storage compartment of claim 7, wherein the cover is mechanically coupled to the base.

10. The portable, temperature controlled food storage compartment of claim 7, wherein, in the collapsed position, at least one of the first and second side panels is mechanically coupled to at least one of the front and rear panels.

11. The portable, temperature controlled food storage compartment of claim 1, wherein the top panel includes a vent for the passage of air and moisture exiting the interior volume of the compartment.

12. The portable, temperature controlled food storage compartment of claim 3, wherein, in the closed position, a gap is formed between one of the number of side panels and the rear panel for the passage of air entering the interior volume of the compartment.

13. The portable, temperature controlled food storage compartment of claim 1, wherein the temperature controlling element is a heating element.

14. The portable, temperature controlled food storage compartment of claim 1, wherein, in the closed position, the detachable cover is fixably attached to the base with one or more retaining clips.

15. The portable, temperature controlled food storage compartment of claim 1, wherein the front panel is configurable in a closed panel position in which a portion of the front panel is detachably connected to the number of side panels, and the front panel is configurable in an open panel position in which the front panel is at least partially stowed in the interior cavity through compound rotational and sliding movement of the front panel relative to the top panel.

16. The portable, temperature controlled food storage compartment of claim 15, wherein the front panel includes a handle for lifting the panel and stopping slidable movement of the front panel relative to the top panel.

17. A portable, temperature controlled food storage compartment comprising:
a base having an internal cavity including a temperature controlling element for controlling the temperature of food stored in the compartment; and
a detachable cover configurable in a food storage position and a collapsed position, the detachable cover including a plurality of foldable, peripheral panels and a top panel, and, in the food storage position, two of the plurality of foldable, peripheral panels form a gap for the passage of air into and out of the food storage compartment.

18. The portable, temperature controlled food storage compartment of claim 17, wherein the plurality of foldable, peripheral panels includes a number of side panels and a front panel.

19. A portable, temperature controlled food storage compartment comprising:
a base having an internal cavity including a temperature controlling element for controlling the temperature of food stored in the compartment; and
a detachable cover including opposing and spaced apart first and second side panels, a front panel, a rear panel and a top panel, the first and second side panels are pivotally connected to the top panel, the front and rear panels are pivotally connected to the first and second side panels, the cover is configurable in a food storage position in which a lower edge portion of each of the number of side panels is coupled to the base to form an interior volume at least partially defined by the base and the cover and for storing food, and the cover is configurable in a collapsed position in which at least one surface portion of at least one of the number of side panels and the top panel contacts the base.

20. The portable, temperature controlled food storage compartment of claim 19, wherein the front and rear slide panels are slidably connected to the first and second side panels for substantially perpendicular movement relative to the first and second side panels.

21. The portable, temperature controlled food storage compartment of claim 19, further comprising a rack for supporting food and wherein the first and second side panels each include a for supporting the rack.

22. The portable, temperature controlled food storage compartment of claim 19, wherein the temperature controlling element is a heating element.
